(19) United States
(12) Patent Application Publication
(10) Pub. No.: US 2017/0122817 A1
(43) Pub. Date: May 4, 2017

(54) COOLING MONITOR THERMOMETER DEVICE AND SYSTEM FOR MONITORING AND LOGGING THE COOLING OF FOOD

(71) Applicant: Anthony Jerald Willert, Albuquerque, NM (US)

(72) Inventors: Anthony Jerald Willert, Albuquerque, NM (US); Parker Roan, Homewood, AL (US)

(21) Appl. No.: 15/341,357

(22) Filed: Nov. 2, 2016

Related U.S. Application Data
(60) Provisional application No. 62/249,396, filed on Nov. 2, 2015.

(51) Int. Cl. G01K 13/00; G01K 1/02

(52) U.S. Cl. CPC G01K 13/00; G01K 1/028; G01K 1/024; G01K 2207/02

(57) ABSTRACT

A cooling monitor thermometer device and a system for monitoring and logging the cooling of food. The cooling monitor thermometer device includes a display, a control panel, and a probe. The cooling monitor thermometer that can measure the temperature of a food or liquid medium in a temperature mode, an initialization mode, and a monitoring and logging mode to capture and log a hot food cool down process or a cold food cool down process at certain initial temperatures and logging temperatures with corresponding times. The captured and logged temperatures and times may be transmitted from the cooling monitor thermometer via a network to a program platform on a logging device.

### CROSS REFERENCE TO RELATED APPLICATIONS

The present application claims priority to U.S. Provisional Patent Application No. 62/249,396, filed on Nov. 2, 2015.

### FIELD OF THE DISCLOSURE

This disclosure relates generally to food temperature, more particularly, to cooling monitor thermometer device and a food cooling monitoring and logging system.

### BACKGROUND

Foodborne illness is the number one concern within the food service industry. The improper cooling of food is a leading cause of foodborne illnesses. Food service regulatory agencies require cooling monitor logs that provide the proper logging of the food cooling process. The monitoring and logging of equipment and food temperatures is a never-ending process in kitchens but is routinely done incorrectly. Refrigeration temperatures need to be monitored continuously and documented periodically to ensure food is being stored properly. Food temperatures are monitored and documented through the cooking, holding, and cooling processes. This current process requires logging of the initial time hot food registers at 135 degrees Fahrenheit (but can vary in some jurisdictions such as at 140 degrees Fahrenheit). Then, after two hours, the temperature has to be recorded to ensure that the food has cooled to below 70 degrees Fahrenheit. Finally, after six hours of cooling, the food temperature has to be recorded to ensure that it has dropped below 41 degrees Fahrenheit. This monitoring and logging is done to ensure the food being served has not been compromised leading to foodborne illness.

Within the food industry, the steps to record and log the cooling process are usually not completed due to timing, monitoring, and staff issues. As monitoring and documenting the cooling of food is done manually, personnel may fail to remember to document the cooling temperature in the mandated time frames or there may be a lack of proper staff. Food may also need to be cooled at times when no staff is available to monitor and document the cooling process. Along with these barriers to properly monitor and document the cooling of food, there may also be a lack of employee/staff education on the cooling process and proper corrective action of improperly cooled foods. Therefore, the recording and logging of food temperature are usually not done properly, or at all, increasing the likelihood of fraudulent logging. This lack of correctly monitoring and recording food temperature may ultimately lead to foodborne illnesses.

Previous devices and systems for monitoring and documenting the cooling process of food have based the cooling on time rather than temperature which does conform to the proper procedures and logging that require the time it takes for food to get from one temperature to another and if the time interval was met. Additionally, many devices use lights, alarms, and other warnings which are not useful as most food is cooled in large walk-in refrigerators and out of sight of kitchen staff. In light of this, there is a need in the art for a device and system that easily measures, monitors, and records the proper cooling of food based on temperature over time requirements.

### BRIEF SUMMARY OF THE DISCLOSURE

The following presents a simplified summary of the disclosure in order to provide a basic understanding of some aspects of the invention. This summary is not an extensive overview of every embodiment disclosed herein. It is intended to neither identify key or critical elements of the various embodiments nor delineate the scope of the disclosure. Its sole purpose is to present some concepts of the disclosure, in accordance with the various embodiments disclosed herein, in a simplified form as a prelude to the more detailed description that is presented later.

In one aspect, the present disclosure describes a device and a system that can be used to monitor and record the cooling of food based on temperature readings over time frames.

In another aspect, the present disclosure describes a device and a system that can be used to monitor, record, and document stored temperature and time data during the food cooling process.

In another aspect, the present disclosure describes a device and a system that can be used to monitor, record, and document a hot food cool down process for food products.

In yet another aspect, the present disclosure describes a system that can be used to monitor, record, and document a cold food cool down process for food products.

In another aspect, the present disclosure describes a device and a system that can be used to alert a user to certain actions in the kitchen during the proper cooling down process of food.

In yet another aspect, the present disclosure describes a device that may be used as a thermometer to measure food temperature.

The following description and the annexed drawings set forth certain illustrative aspects of the embodiments of the disclosure. These aspects are indicative, however, of but a few of the various ways in which the principles of the disclosure may be employed and the various embodiments are intended to include all such aspects and their equivalents. Other advantages and novel features will become apparent from the following description when considered in conjunction with the drawings.

### BRIEF DESCRIPTION OF THE FIGURES

FIG. 1 illustrates a perspective view of an embodiment of a cooling monitor thermometer device in accordance with the disclosure.

FIG. 2 illustrates a front view of an embodiment of a cooling monitor thermometer device in accordance with the disclosure.

FIG. 3 illustrates a top perspective view of an embodiment of a cooling monitor thermometer device in accordance with the disclosure.

FIG. 4 illustrates a flow chart of an embodiment of a cooling monitor thermometer device and the cool down monitoring and logging system including a description of the temperature, initialization, and monitoring and logging modes.

FIG. 5 is a block diagram of an embodiment of the cool down monitoring and logging system which may express the aspects of how the system initiates the cool down monitor and logging system.

FIG. 6 is a block diagram of an embodiment of the cool down monitoring and logging system which may express the aspects of the hot food cool down process.

FIG. 7 is a block diagram of an embodiment of the cool down monitoring and logging system which may express the aspects of the cold food cool down process.

### DETAILED DESCRIPTION OF ILLUSTRATIVE EMBODIMENTS

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

As used herein, an element or step recited in the singular and proceeded with the word “a” or “an” should be understood as not excluding plural of said elements or steps, unless such exclusion is explicitly stated. In this document, the term “or” is used to refer to a nonexclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

In the following detailed description, reference is made to the drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense.

As will be appreciated by those skilled in the art, portions of the present disclosure may be embodied as a method, data processing system, or computer program product. Accordingly, these portions of the present disclosure may take the form of an entirely hardware embodiment, an entirely software embodiment, or an embodiment combining software and hardware aspects. Furthermore, portions of the present disclosure may be implemented as a computer program product on a computer-usable storage medium having computer readable program code on the medium. Any suitable computer readable medium may be utilized including, but not limited to, static and dynamic storage devices, hard disks, optical storage devices, and magnetic storage devices.

The present innovation is described below with reference to illustrations of methods, systems, and computer program products according to embodiments of the invention. It will be understood that blocks of the illustrations, and combinations of blocks in the illustrations, can be implemented by computer program instructions, hardware devices, or a combination of both. These computer program instructions may be provided to a processor of a general purpose computer, special purpose computer, or other programmable data processing apparatus to produce a particular machine, such that the instructions, which execute via the processor of the computer or other programmable data processing apparatus, implement the functions specified in the block or blocks.

Embodiments of present innovation may be implemented on one or more computing devices, including one or more servers, one or more client terminals, including computer terminals, a combination thereof, or on any of the myriad of computing devices currently known in the art, including without limitation, personal computers, laptops, notebooks, tablet computers, touch pads (such as the APPLE IPAD, SmartPad ANDROID tablet, etc.), multi-touch devices, smart phones, personal digital assistants, other multi-function devices, stand-alone kiosks, etc.

The various embodiments and/or components, for example, the modules, elements, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, and any other circuit or processor capable of executing the functions described herein. The above examples are exemplary only, and are thus not intended to limit in any way the definition and/or meaning of the term “computer.”

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

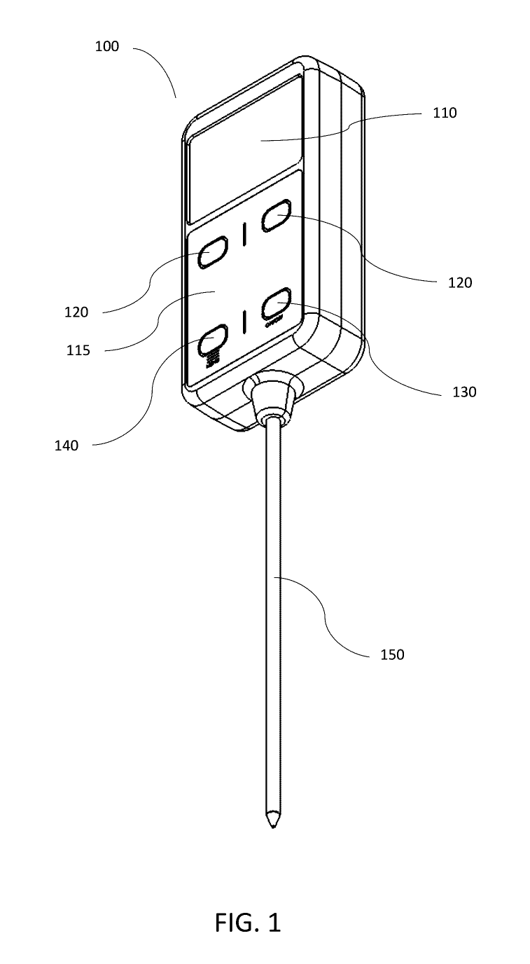

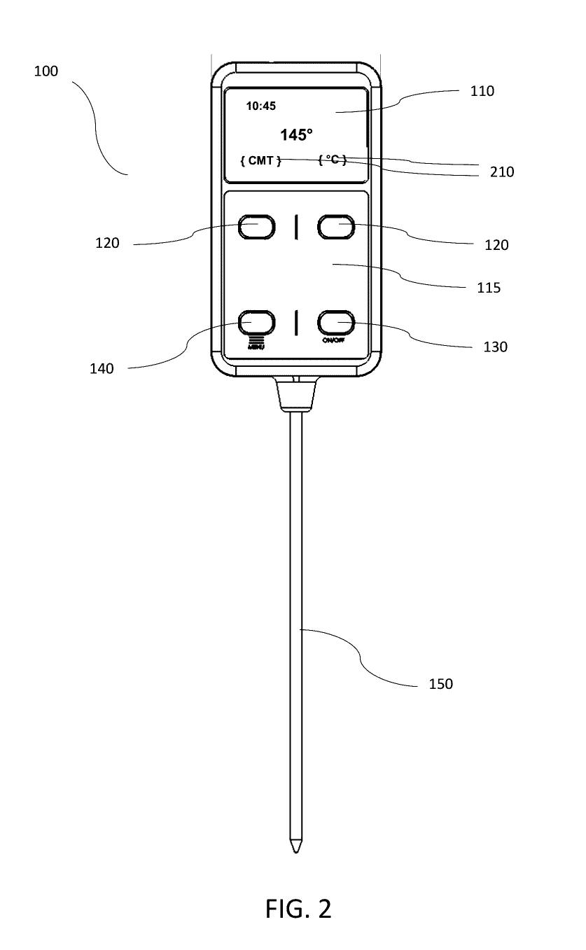

With reference to FIGS. 1 and 2, a cooling monitor thermometer device 100 is provided for monitoring and logging the cooling of food. The cooling monitor thermometer 100 may include a display 110, a control panel 115, and a probe 150. The cooling monitor thermometer 100 may be water resistant and include a rechargeable battery. In one embodiment, the display 110 may be a liquid crystal display (LCD). The control panel 115 may comprise of a plurality of selection buttons 120, a menu button 140, and a power button 130. The cooling monitor thermometer 100 may also comprise of a wireless network or be BLUETOOTH ready enabling the cooling monitor thermometer 100 to connect to a wireless network or to other BLUETOOTH ready devices.

The display 110 may include a plurality of action displays 210 that relate to the functions and modes of the cooling monitor thermometer 100. The action displays 210 may include a temperature reading, a time frame clock, a date reading, a battery power meter, a Celsius/Fahrenheit conversion, a BLUETOOTH or wireless signal, and a cooling monitor thermometer (CMT) setting. The selection buttons 120 may allow a user to select and change the action displays 210 on the display 110.

The menu button 140 may be used to enter and exit the cooling monitor thermometer 100 menu where thermometer information may be updated or changed including a twelve-hour time or a twenty-four hour time. The menu button 140 may allow a user to change an initial temperature designation to initiate a hot food cooling process or a cold food cooling process based on varying state/federal regulations or for personal preference. In another embodiment, the menu button 140 may allow a user to turn on or off ancillary functions such as BLUETOOTH. The menu button 140 may also allow a user to save all updated data. The power button 130 may allow a user to turn the cooling monitor thermometer on or off. The selection buttons 120, menu button 140, and power button 130 may all be pressed to wake the cooling monitor thermometer 100 from a sleep or power save mode.

The probe 150 may extend from a bottom portion of the cooling monitor thermometer 100. The probe 150 may be inserted into a food or liquid item that will be measured and recorded. The probe allows for a temperature reading to be measured and read on the display. The probe 150 may comprise of a thermistor to read the temperature. In another embodiment, the probe 150 may comprise of a cord that extends from the cooling monitor thermometer 100 and connects to the probe 150. In another embodiment, the probe 150 may be detachable.

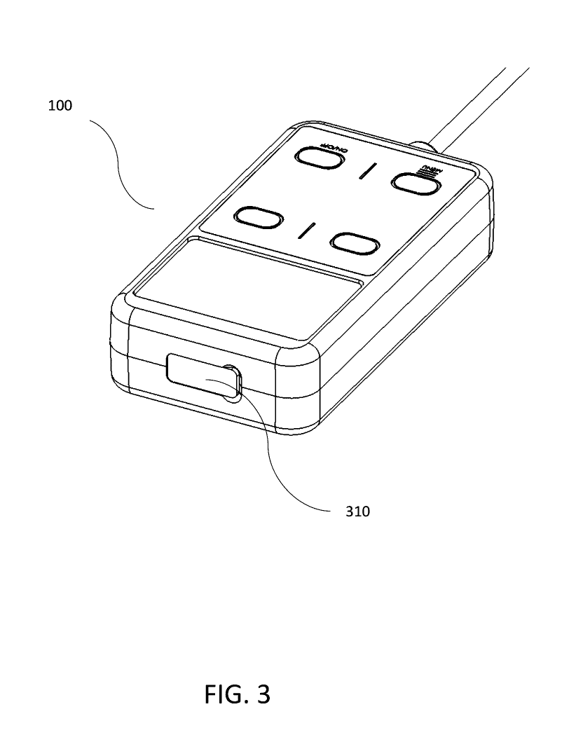

With reference to FIG. 3, the cooling monitor thermometer 100 may comprise of a charging/reprogramming port 310. The charging/reprogramming port 310 may be placed on a top end of the cooling monitor thermometer 100. The charging/reprogramming port 310 may be covered by a charge plug. The charging/reprogramming port 310 may allow a user to charge the cooling monitor thermometer battery. The charging/reprogramming port 310 may also allow a user to reprogram or update device information from an external source such as a computer, smartphone, tablet, or laptop.

The cooling monitor thermometer 100 may also include an attachment mechanism. The attachment mechanism may allow the cooling monitor thermometer to attach to a pot for liquid cooling. In one embodiment, the attachment mechanism may be placed on the rear of the cooling monitor thermometer 100. In another embodiment, the attachment mechanism may be placed on the probe 150.

The cooling monitor thermometer 100 may also include an alarm system to notify a user of certain actions such as to place food in a refrigerator. In one embodiment, the alarm system may comprise of a plurality of lights on the control panel 115 or as an action display 210 on the display 110. In another embodiment, the alarm system may comprise of an audio system that generates sounds to alert a user of certain actions to take during the cool down monitoring and logging process.

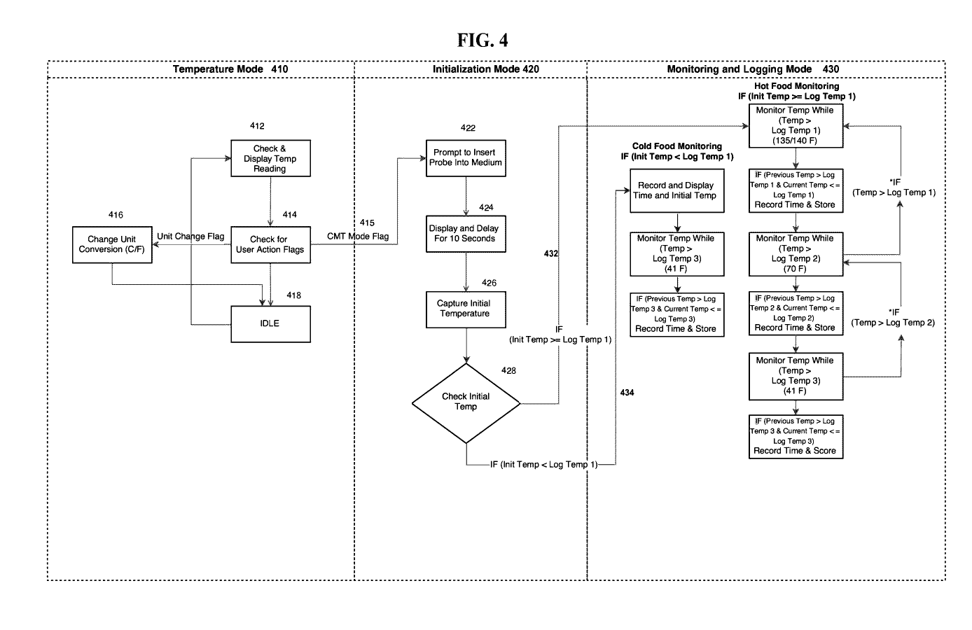

A system for monitoring and logging the cooling of food using the cooling monitor thermometer 100 is illustrated in FIGS. 4-7. The cooling monitor thermometer device 100 may provide for a temperature mode 410, an initialization mode 420, and a monitoring and logging mode 430. In one embodiment, when the cooling monitor thermometer 100 is in the temperature mode 410, a user may use the selection buttons 120 and menu button 140 to display a temperature reading 412, change a unit conversion 416, or check for the plurality of action displays 210. A user may also allow the cooling monitor thermometer device 100 remain in an idle position 418 during the temperature mode 410. A user may use the selection buttons 120 or menu button 140 to activate the CMT mode action display 415 to activate the cooling monitor temperature 100 into the initialization mode 420. During the initialization mode 420, a user may insert the probe 150 of the cooling monitor thermometer 100 into a medium 422. The medium may comprise a food item or a liquid item. The cooling monitor thermometer 100 will have a delay 424 before capturing an initial temperature 426 of the medium. When the initial temperature is captured by the cooling monitor thermometer 100, the thermometer 100 will activate the monitoring and logging mode 430. Depending on the initial temperature reading, the monitoring and logging mode 430 may capture and log temperature readings and times in a cold food cool down monitoring and logging process 432 or a hot food cool down monitoring and logging process 434.

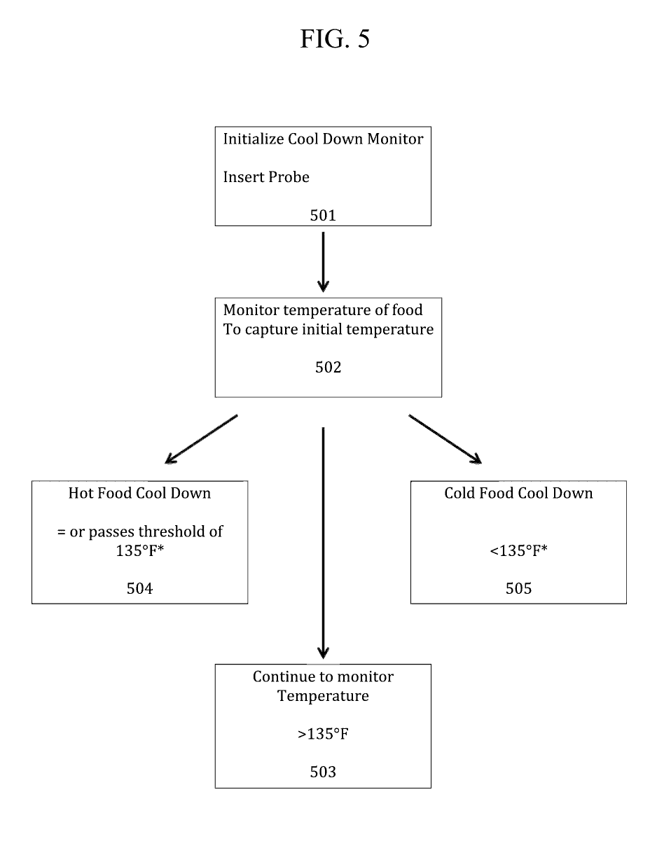

FIG. 5 illustrates one embodiment of the initialization mode. In step 501 the cool down monitoring and logging system is initialized by inserting the probe 150 of the cooling monitor thermometer 100 into a food or liquid medium. In this step, the cooling monitor thermometer has been turned on by the power button 130 and switched to the CMT mode 415 by the selection buttons 120 or menu button 140 on the cooling monitor thermometer 100. In step 502 the cooling monitor thermometer 100 begins to monitor the temperature of the food or liquid item to capture an initial temperature. In step 503 the cooling monitor thermometer 100 may continue to monitor temperature if the medium being monitored remains above the initial temperature. In one embodiment, the initial temperature may be at 135 degrees Fahrenheit. In another embodiment, the initial temperature may be an alternate initial temperature set by a user on the cooling monitor thermometer 100. For example, local regulations may require food and liquid temperatures to be logged at 140 degrees Fahrenheit instead of the federally mandated 135 degrees Fahrenheit. In other instances, a user may prefer to set the alternate initial temperature to any desired degree Fahrenheit or Celsius. Therefore, a user may adjust the initial temperature to the alternate initial temperature to meet these guidelines or personal preferences. In step 504, the cooling monitor thermometer 100 may capture and record the initial temperature of the food or liquid and an initial time from which initiates the hot food cool down monitoring and logging process. In one embodiment, the initial temperature of 135 degrees Fahrenheit initiates the hot food cool down monitoring and logging process. In another embodiment, the initial hot food temperature may be adjusted by a user to the alternate initial temperature using the control monitor thermometer 100 that initiates the hot food cool down monitoring and logging process. In step 505 the cooling monitor thermometer may capture and record the initial temperature of the food or liquid item and the initial time to initiate the cold food cool down monitoring and logging process. In one embodiment, the initial temperature less than 135 degrees Fahrenheit but above 41 degrees Fahrenheit initiates the cold food cool down monitoring and logging process. In another embodiment, the initial temperature may be less than the alternate initial temperature that initiates the cold food cool down monitoring process.

The cooling monitor thermometer device 100 uses the initial temperature captured in the initialization mode to decide whether to initiate the hot food cool down monitoring and logging process or cold food cool down monitoring and logging process. The captured initial temperatures may be transmitted over a network to a program on at least one logging device for storage and logging.

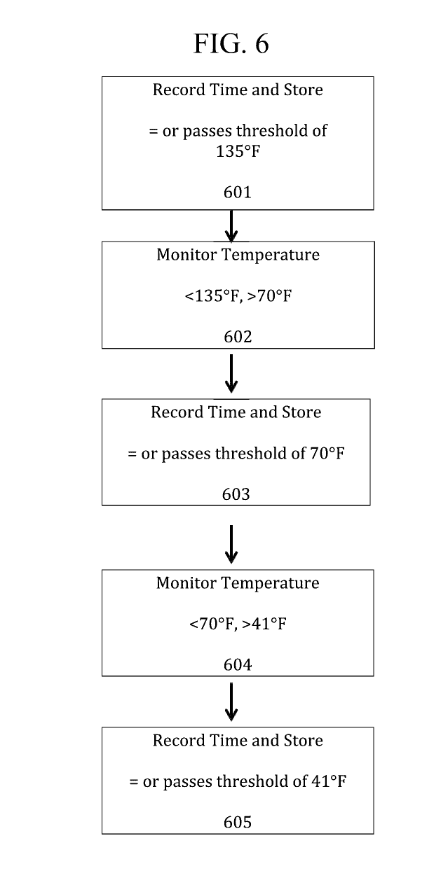

FIG. 6 illustrates one embodiment for the hot food cool down monitoring and logging process. In step 601 the cooling monitor thermometer 100 captures and logs the initial temperature at 135 degrees Fahrenheit or at the alternate initial temperature as set by the user on the cooling monitor thermometer 100. In step 602 the cooling monitor thermometer 100 will continue to monitor and read the temperature of the food or liquid item after the hot food cool down process has been initiated. In one embodiment, the cooling monitor thermometer 100 may monitor the medium from the initial temperature until the medium reaches 70 degrees Fahrenheit. In step 603 the cooling monitor thermometer 100 will capture and log a first hot food log temperature and a first hot food log time. In one embodiment, the first hot food log temperature in step 603 may be 70 degrees Fahrenheit, and the hot food log time will be captured when the medium hits 70 degrees. In step 604 the cooling monitor thermometer may continue to monitor and read the temperature of the food or liquid item after capturing and logging the first hot food log temperature. In one embodiment, the cooling monitor thermometer 100 may monitor the food item from the first hot food log temperature until the medium reaches 41 degrees Fahrenheit. In step 605 the cooling monitor thermometer 100 will capture and log a final hot food temperature and a final hot food time. In one embodiment, the final hot food temperature may be 41 degrees Fahrenheit.

The captured first and final hot food log temperatures and first and final hot food log times may be transmitted over a network to a program on at least one logging device for storage and logging. In one embodiment, the alarm system will alert a user to refrigerate the food item when it reaches the first hot food log temperature.

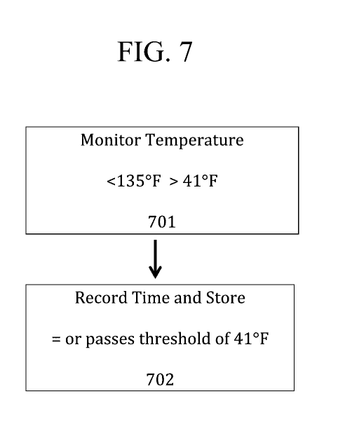

FIG. 7 illustrates one embodiment of a system for the cold food cool down monitoring and logging process. In step 701 the cooling monitor thermometer 100 will monitor and measure the temperature of the medium starting from the initial temperature less than 135 degrees Fahrenheit or the initial temperature less than the alternate initial temperature to a final cold food log temperature. In step 702 the cooling monitor thermometer will capture and log the final cold food log temperature and a final cold log food time. In one embodiment, the final cold food log temperature may be at 41 degrees Fahrenheit. The captured initial temperature and time and the final cold food log temperature and time may be transmitted over a network to a program on at least one logging device for storage and logging.

All the initial temperatures and initial times, as well as all the log temperatures and log times captured during the initialization mode and monitoring and logging mode may be transmitted via a network to a user program platform on at least one logging device. The logging devices may comprise of personal computers, laptops, notebooks, tablet computers, touch pads, multi-touch devices, smart phones, personal digital assistants, and other multi-function devices. The network may comprise of wireless networks, including but not limited to WiFi or BLUETOOTH. The cooling monitor thermometer 100 may be equipped with WIFI or BLUETOOTH connectivity that may allow for the transmission of initial and log temperatures and times to the logging devices which may have the user program platform to store, assess, display, and print the temperatures and times. The temperatures and times may be stored as historical data, assessed and displayed to ensure that correct actions are taken if the historical data does not meet specified criteria. In another embodiment, the initial and log temperatures and times may be printed for correct and accurate labeling of food or liquid.

The descriptions set forth above are meant to be illustrative and not limiting. Various modifications of the embodiments, in addition to those described herein, will be apparent to those skilled in the art from the foregoing description. Such modifications are also intended to fall within the scope of the concepts described herein. Each patent, patent application and publication cited or described in this document are hereby incorporated herein by reference, in their entireties.

The foregoing description of possible implementations consistent with the present disclosure does not represent a comprehensive list of all such implementations or all variations of the implementations described. The description of some implementation should not be construed as an intent to exclude other implementations. For example, artisans will understand how to implement the embodiments in many other ways, using equivalents and alternatives that do not depart from the scope of the disclosure. Moreover, unless indicated to the contrary in the preceding description, none of the components described in the implementations are essential to the embodiments disclosed. It is thus intended that the embodiments be considered as illustrative, with a true scope and spirit of the disclosure being indicated by the following claims. Furthermore, to the extent that the term “includes” is used in either the detailed description or the claims, such term is intended to be inclusive in a manner similar to the term “comprising” as “comprising” is interpreted when employed as a transitional word in a claim. Further, the limitations of the following claims are not written in means—plus-function format and are not intended to be interpreted based on 35 U.S.C. §112(f), unless and until such claim limitations expressly use the phrase “means for” followed by a statement of function void of further structure.

1. A cooling monitor thermometer device comprises:
a display with a temperature reading, a time reading, a plurality of action displays;
a probe that may be inserted into a medium.
a control panel with a plurality of selection buttons, a menu button, and a power button;
a rechargeable battery,
a charging port wherein the cooling monitor thermometer device may be reprogrammed or updated from an external source.
a temperature mode wherein the cooling monitor thermometer reads and displays a temperature reading;
an initialization mode wherein the cooling monitor thermometer captures an initial temperature;
a monitoring and logging mode wherein the cooling monitor thermometer monitors and logs a plurality of log temperatures and plurality of log times in a hot food cool down process or in a cold food cool down process.

2. The cooling monitor thermometer device of claim 1, wherein the display is a liquid crystal display.

3. The cooling monitor thermometer device of claim 1, wherein the cooling monitor thermometer device is water resistant.

4. The cooling monitor thermometer device of claim 1, comprising of an alarm system.

5. A system for monitoring and logging the cooling of food comprising:
providing a cooling monitor thermometer with a temperature mode, an initialization mode, and a monitoring and logging mode;
capturing an initial temperature and an initial time of a food or liquid with the cooling monitor thermometer in the initialization mode;
initiating the monitoring and logging mode wherein the initial temperature initiates a hot food cool down process or a cold food cool down process;
monitoring and logging a first log temperature, a first hot food log time, a final hot food log temperature, and a final log time in the hot food cool down process,
monitoring and logging of a final cold food log temperature and final cold food log time in the cold food cool down process;
transmitting the initial temperature, the initial time, the first hot food log temperature, the first hot food log time, the final hot food log temperature, the final hot food log time, the final cold food log temperature, and the final cold food log time via a wireless network;
receiving the transmitted initial temperature, initial time, and log temperatures on a user program platform on at least one logging device.

6. The system of claim 5, wherein the initial temperature of 135 degrees Fahrenheit initiates the hot food cool down process, and the initial temperature less than 135 degrees Fahrenheit initiates the cold food cool down process.

7. The system of claim 5, wherein the first hot food log temperature in the hot food cool down process is 70 degrees Fahrenheit, and the final hot food log temperature in the hot food cool down process is 41 degrees Fahrenheit.

8. The system of claim 5, wherein the final cold food log temperature in the cold food cool down process is 41 degrees Fahrenheit.

9. The system of claim 5, wherein the initial temperature may be an alternate initial temperature set by a user to initiate the hot food cool down process and the initial temperature may be less than the alternate initial temperature to initiate the cold food cool down process.

10. A system for monitoring and logging the cooling of food comprising:
providing a cooling monitor thermometer with a temperature mode, an initialization mode, and a monitoring and logging mode;
capturing an initial temperature and an initial time of a food or liquid with the cooling monitor thermometer in the initialization mode;
initiating the monitoring and logging mode wherein the initial temperature of 135 degrees Fahrenheit initiates a hot food cool down process, and the initial temperature less than 135 degrees Fahrenheit initiates a cold food cool down process.
initiating the monitoring and logging mode wherein the initial temperature may be an alternate initial temperature set by a user to initiate the hot food cool down process, and the initial temperature may be less than the alternate initial temperature to initiate the cold food cool down process.
monitoring and logging a first hot food log temperature, first hot food log time, a final hot food log temperature, and a final hot food log time in the hot food cool down process wherein the first hot food log temperature is 70 degrees Fahrenheit and the final hot food log temperature is 41 degrees Fahrenheit.
monitoring and logging of a final cold food log temperature and a final cold food log time in the cold food cool down process wherein the final cold food log temperature is 41 degrees Fahrenheit;
transmitting the initial temperature, the initial time, the first hot food log temperature, the first hot food log time, the final hot food log temperature, the final hot food log time, the final cold food log temperature, and the final cold food log time via a wireless network;
receiving the transmitted initial temperature and initial time and log temperatures and times on a user program platform on at least one logging device.
